(19) United States
(12) Patent Application Publication
(10) Pub. No.: US 2026/0085579 A1
(43) Pub. Date: Mar. 26, 2026

(54) ADJUSTABLE LADDER STABILIZER

(71) Applicant: DR Innovations LLC, Montrose, CO (US)

(72) Inventor: Daniel Russell, Montrose, CO (US)

(21) Appl. No.: 18/891,660

(22) Filed: Sep. 20, 2024

(51) Int. Cl. E06C 7/18

(52) U.S. Cl. CPC E06C 7/188

(57) ABSTRACT

A stabilizer for an upright support of a ladder or scaffolding a base, a stabilizing arm, and a joint. The base includes at least one moveable component and a clamping component. A portion of the base is shaped to at least partially encompass the upright support. The clamping component exerts force on the moveable component to hold the base in a fixed position on the upright support when at least partially encompassed within the base. The joint couples the stabilizing arm to the base. The stabilizing arm pivots about at least one axis at the joint.

### TECHNICAL FIELD

Embodiments of the invention relate to the field of ladders and scaffolding. More specifically, embodiments relate to a stabilizer for an upright support of a ladder or scaffolding and is adjustable about at least one axis.

### BACKGROUND

Ladder stabilizers, also referred to as ladder standoffs, attach to the side rails of a ladder to provide additional stability and/or adapt the points of contact for the top or base of the ladder. For example, a ladder foot stabilizer can increase the ladder’s base, providing a more secure foundation than the ladder without the stabilizer by widening the base support, adapting to points of contact of differing elevation, etc. As another example, a ladder stabilizer can provide contact points for the upper portion of a ladder as a standoff from a corner, column, roofline, window, etc. when the ladder rails would otherwise make contact with a fragile, unstable, uneven, or small surface.

### BRIEF DESCRIPTION OF THE DRAWINGS

The invention may best be understood by referring to the following description and accompanying drawings that are used to illustrate embodiments of the invention. In the drawings:

FIG. 1 illustrates a pair of ladder stabilizers that are adjustable about at least one axis, according to some embodiments of the invention.

FIG. 2 illustrates another view of a portion of an adjustable ladder stabilizer, according to some embodiments of the invention.

FIG. 3 illustrates yet another view of a portion of the adjustable ladder stabilizer, according to some embodiments of the invention.

FIG. 4 illustrates another pair of ladder stabilizers that are adjustable about at least one axis, according to some embodiments of the invention.

FIG. 5 illustrates an exploded view of components of an adjustable ladder stabilizer, according to some embodiments of the invention.

FIG. 6 illustrates yet another ladder stabilizer that is adjustable about at least one axis, according to some embodiments of the invention.

FIG. 7 illustrates an exploded view of components of another adjustable ladder stabilizer, according to some embodiments of the invention.

FIG. 8 illustrates examples of ladders and scaffolding using adjustable stabilizer arms, according to some embodiments of the invention.

### DETAILED DESCRIPTION

Conventional ladder stabilizers include arms that provide wider points of contact and/or a standoff for the ladder. While some ladder stabilizer arms are adjustable to different widths, they are adjustable in a single dimension and otherwise remain fixed with respect to their orientation with respect to the ladder. Some ladder stabilizers provide extendible base points to allow the bottom a ladder to be placed upright while making contact with an uneven ground surface. Again, these extendible base stabilizers remain fixed with respect to their orientation with respect to the ladder. As a result, conventional ladders stabilizers are often limited in functionality and multiple different ladders stabilizers may be required to adapt to different situations.

Aspects of the present disclosure address the above and other deficiencies by setting forth a stabilizer for an upright support of a ladder or scaffolding that is adjustable about at least one axis. For example, rather than simply extending along a single plane, the present disclosure describes a stabilizer that can rotate around one or more axes near a connection point to the upright support. As a result, the adjustable stabilizer can be employed in a greater variety of positions and uses than conventional stabilizers, eliminating the need for employing a different, fixed stabilizer for each different scenario.

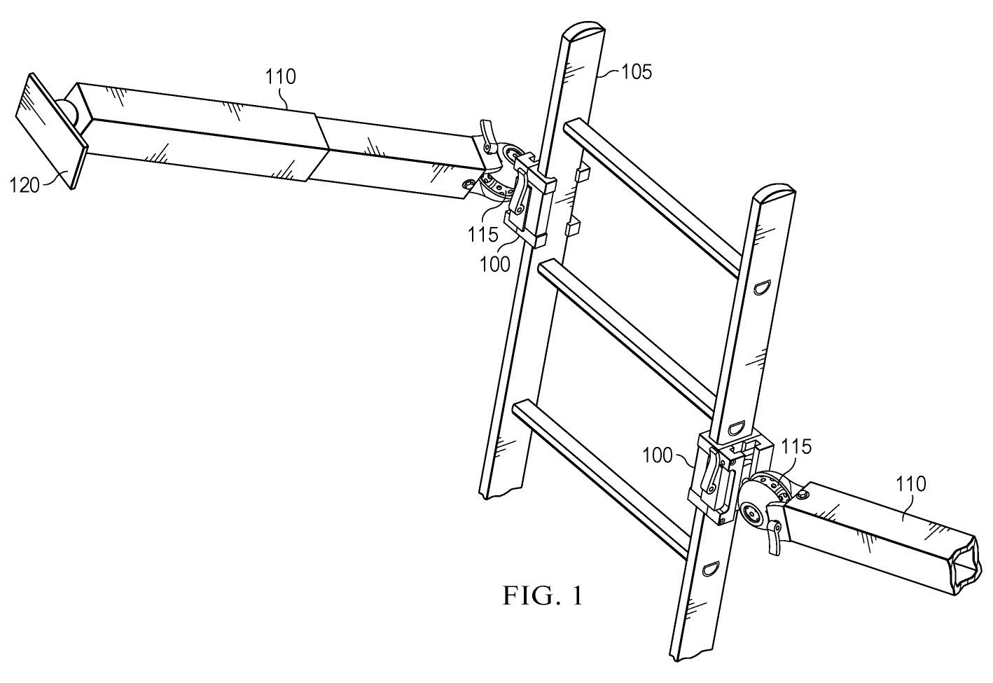

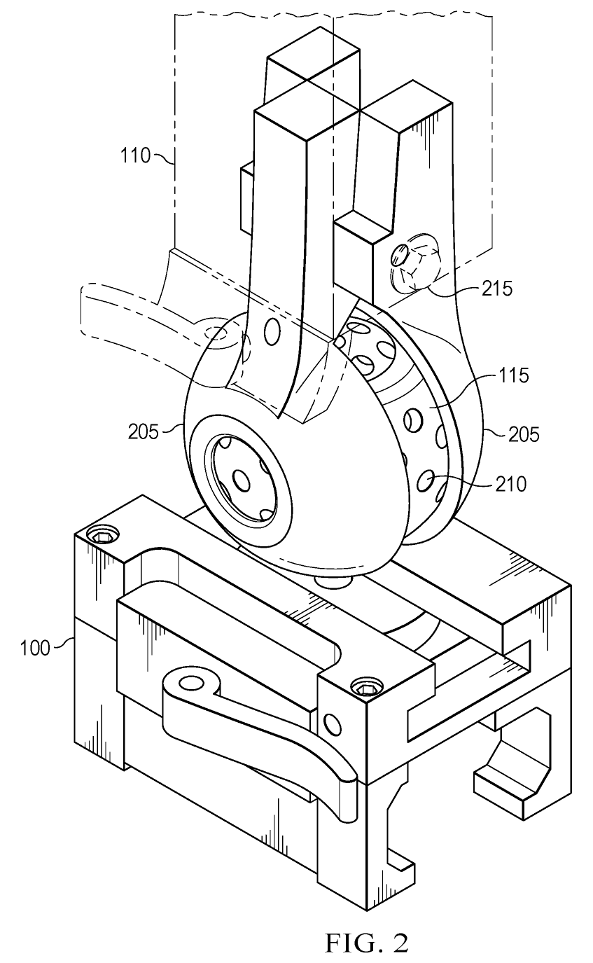

FIG. 1 illustrates a pair of ladder stabilizers that are adjustable about at least one axis, according to some embodiments of the invention. While the embodiments described throughout refer to ladder stabilizers, the embodiments also apply to stabilizing arms for other upright supports, such as the upright supports of scaffolding or a similar structure. Each stabilizer includes a base 100 that attaches to an upright support 105 of the ladder. In one embodiment, the base 100 is shaped to at least partially encompass an upright support of a ladder or scaffolding. For example, the base 100 can slide over and/or clamp around the upright support 105. The illustrated example of the base 100 includes a quick release lever to control clamping the base 100 via a cam or axle by exerting force on at least one moving component of the base 100 and, in turn, the upright support. In other embodiments, the base 100 clamps around the upright support 105 via another mechanism, such as a track and runner, bolt or screw, or another clamping mechanism. The base 100 is described further below with reference to FIG. 2.

The ladders stabilizers further include extendible arms 110. For example, the illustrated arms 110 extend in a telescopic fashion and can be secured at various lengths. In one embodiment, the arms 110 lock into various adjustable lengths via a spring-loaded pin fixed to an inner telescoping portion of the arm 110 that mates with a series of holes in an outer telescoping portion of the arm 110. In other embodiments, arms 110 lock into adjustable length positions via inserting a pin or bolt through corresponding holes in the inner and outer telescoping portions, via a ratcheting system, or another mechanism.

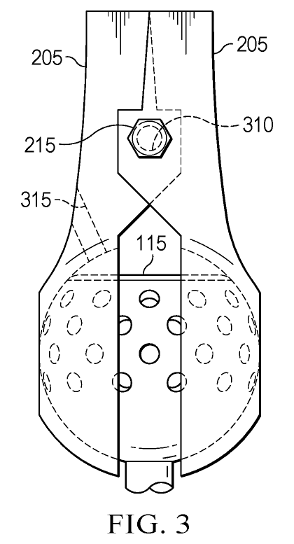

Each base 100 is coupled to an arm 110 via a ball/spheroid joint 115. The ball joint 115 permits the arm 110 to pivot about one or more axes with respect to the base 100. In one embodiment, the ball joint 115 mates with a socket to enable the arm 110 to pivot about a large/indefinite number of axes. In other embodiments, the ball joint 115 is another type of joint, such as a saddle joint, hinge joint, pivot joint, etc. The ball joint 115 is described further below with respect to FIGS. 2 and 3.

Each arm 110 is further coupled to a contact plate 120. The contact plate 120 provides a flat surface to mate with the stabilizing surface, such as a wall, roof, the ground, etc. In one embodiment, the contact plate 120 is coupled to the arm 110 via a ball/spheroid joint or other joint to enable a stabilizing interface that can adapt to various positions of the arms 110.

FIG. 2 illustrates another view of a portion of an adjustable ladder stabilizer, according to some embodiments of the invention. In particular, FIG. 2 provides a closer view of the base 100 and the ball joint 115. The partial view of the arm 110 is shown in broken line to provide a transparent view of the arm 110 in order to show how the arm 110 mates with the ball joint 115. Additionally, the illustrated view provides an example of the clamping mechanism of base 100. For example, this embodiment shows a quick release lever that threads into a bolt or receiving plate on the opposite side of the base 100, enabling one or both bottom portions of the base 100 to move toward the other and be secured in place to clamp around a ladder rail, scaffolding support, etc.

The ball joint 115 is enclosed within a socket 205. The socket 205 includes two halves that together support the ball joint 115. The halves of the socket 205, when not clamped down on the ball joint 115, allow the ball joint 115 to spin and pivot within the socket 205, thus providing the arm 110 with the ability to move about multiple axes. The halves of the socket 205 can clamp down on the ball joint 115 to hold a fixed position, preventing spinning or pivoting. For example, the illustrated embodiment also includes a quick release lever (shown in broken lines) to control clamping the halves of the socket 205 via a threaded bolt, a cam, an axle, etc.

In one embodiment, the ball joint 115 includes holes, dimples, or other indentations 210 to reinforce the clamping and holding of the ball joint 115. For example, the interior surface of the socket 205 can include raised portions (e.g., bumps) or other features on the interior faces of the halves of the socket 205 that mate with the indentations 210 when the socket 205 is clamped down on the ball joint 115. In other embodiments, the interior faces of the halves of the socket 205 and the ball joint 115 can include different features or textures to facilitate a secure hold of the ball joint 115 when the socket 205 is clamped.

In one embodiment, the halves of the socket 205 clamp down on the ball joint 115 by pivoting about a common point. For example, the halves of the socket 205 mate with the arm 110 and are held within the arm via a bolt 215. In addition to securing the socket 205 to the arm 110, the bolt 215 provides a pivot point for the two halves of the socket 205. When clamping force is applied, the two halves of the socket 205 pivot about the bolt 215 and clamp down on the ball joint 115.

FIG. 3 illustrates yet another view of a portion of the adjustable ladder stabilizer, according to some embodiments of the invention. In particular, FIG. 3 provides a closer and different view of the ball joint 115 and the socket 205. Similar to the description above, broken lines are used to provide a transparent view to illustrate interior and hidden surfaces. For example, the bolt 215 passes through bolt hole 310 in each of the halves of the socket 205 as described above.

In some embodiments, the ball joint 115 is a spheroid (i.e., a sphere-like object, but not necessarily an entire sphere). For example, as illustrated, the ball joint 115 is a partial sphere. In other embodiments, the ball joint 115 is spherical.

In some embodiments, the ball joint 115 is secured in a fixed position using a bolt, spring latch, or similar mechanism to allow the ball joint 115 to alternate between a fixed position and free rotation within the socket 205. For example, a bolt or spring latch can pass through a hole 315 in the socket 205 and into an indentation (e.g., an indentation 210) within the ball joint 115 to secure the arm 110 in a fixed position.

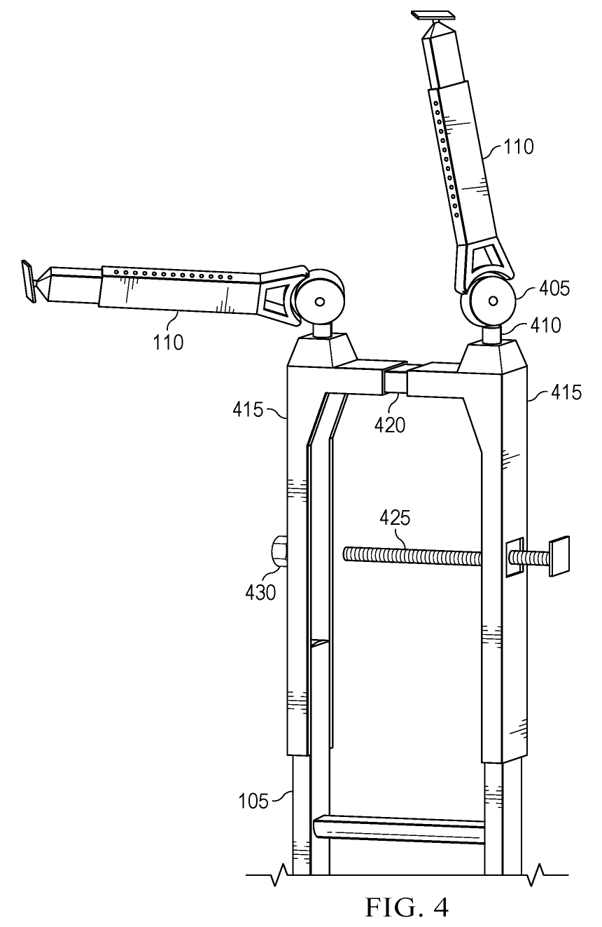

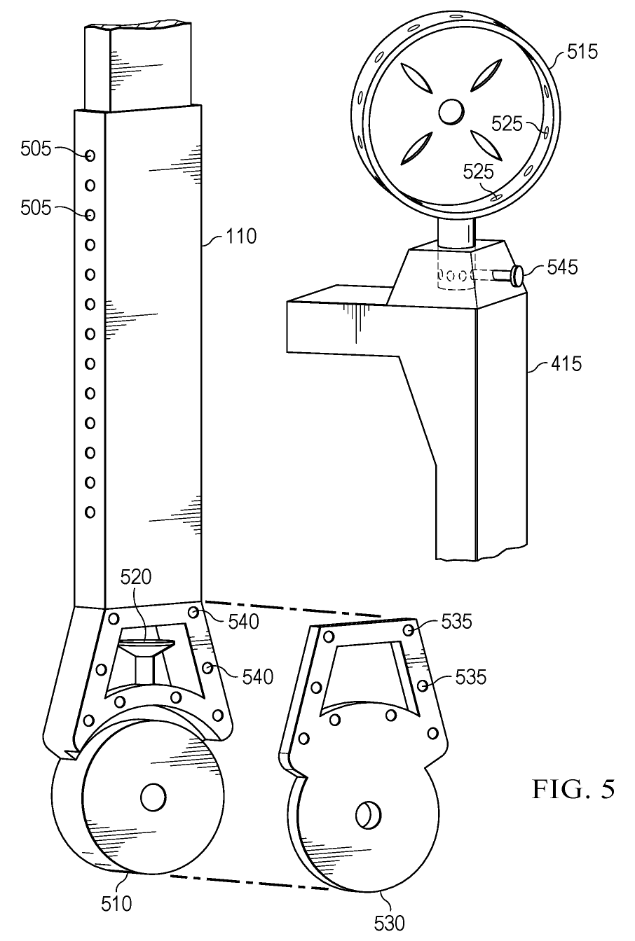

FIG. 4 illustrates another pair of ladder stabilizers that are adjustable about at least one axis, according to some embodiments of the invention. Similar to the embodiments described above, the ladder stabilizers include extendible arms 110. Each arm 110 is coupled to a base 415 via one or more revolute joints 405/410. For example, the disk-shaped joint 405 provides a first revolute joint, providing a single axis of rotation for the corresponding arm 110. Additionally, the cylindrical joint 410 provides a second revolute joint, providing another, yet different, axis of rotation for the corresponding arm 110. For example, with the upright supports of a ladder in a vertical orientation, the revolute joints 405/410 provide an arm 110 with a wide range (up to nearly 360 degrees) of adjustment around a horizontal axis and a vertical axis, respectively. In one embodiment, one revolute joint 405 allows the arm 110 to rotate about an axis that is orthogonal to the axis of rotation of the other revolute joint 410. These revolute joints 405/410 are described further below with reference to FIG. 5.

In one embodiment, the left base 415 and right base 415 each at least partially encloses a corresponding upright support 105 of the ladder. The bases 415 are coupled via a connector 420. For example, the connector 420 mates with each base 415 to allow the ladder stabilizer to change in width in a telescopic manner. As a result, the ladder stabilizer can accommodate ladders of different widths. Additionally, a bolt 425 can pass through the upright supports 105 of a ladder and mate with a nut 430 to secure the bases 415 to the ladder. For example, the ladder can include holes in the upright supports 105 and pass through the rungs of the ladder. As such, the bolt 425 can pass through a hole in one base 415, through the upright supports 105 and a ladder rung, and through a corresponding hole in the other base 415. Once passed through, the bolt 425 is secured using the nut 430, which can also serve to clamp the bases 415 around the partially enclosed upright supports 105. Alternatively, the bolt 425 passes through holes in the left and right bases 415 and rests above/on top of the ladder.

FIG. 5 illustrates an exploded view of components of an adjustable ladder stabilizer, according to some embodiments of the invention. This exploded view provides a partial view of an arm 110. For example, as described above, the extendible arm 110 locks into various adjustable lengths via a spring-loaded pin fixed to an inner telescoping portion of the arm 110 that mates with a series of holes 505 in an outer telescoping portion of the arm 110. In alternate embodiments, the arm 110 extends via a ratcheting mechanism, bolt/pin through one of the holes 505, etc.

The exploded view further illustrates components of the disk-shaped joint 405. The disk-shaped joint 405 includes a joint base 510 about which the joint housing 515 rotates. The joint housing 515 is secured in a fixed rotational position via a spring latch/spring-loaded pin 520 or similar pin or bolt. For example, the pin 520 passes through the arm 110 and a hole 525 within the joint housing 515 to hold the disk-shaped joint 405 in a fixed position. The disk-shaped joint 405 further includes a joint housing plate 530 to keep the joint housing 515 within the rotational path around the joint base 510. The joint housing plate 530 is secured to the arm 110 via bolts, screws, or similar components via the plate holes 535 and the corresponding arm holes 540. Additionally, a center hole within each of the joint base 510, the joint housing 515, and the joint housing plate 530 can receive a bolt or similar component to serve as an axis of rotation for the disk-shaped joint 405. Alternatively, a raised cylinder/feature in the center of the joint base 510 can mate with one or both center holes of the joint housing 515 and/or the joint housing plate 530 to serve as the axis of rotation.

In one embodiment, the joint housing 515 includes an additional revolute joint that provides another axis of rotation for the arm 110. For example, the cylindrical support that couples the joint housing 515 to the base 415 can rotate within the base 415. Additionally, the joint housing 515 is secured in a fixed rotational position relative to the base 415 via another spring latch 545 (or similar spring-loaded pin, screw, bolt, etc.).

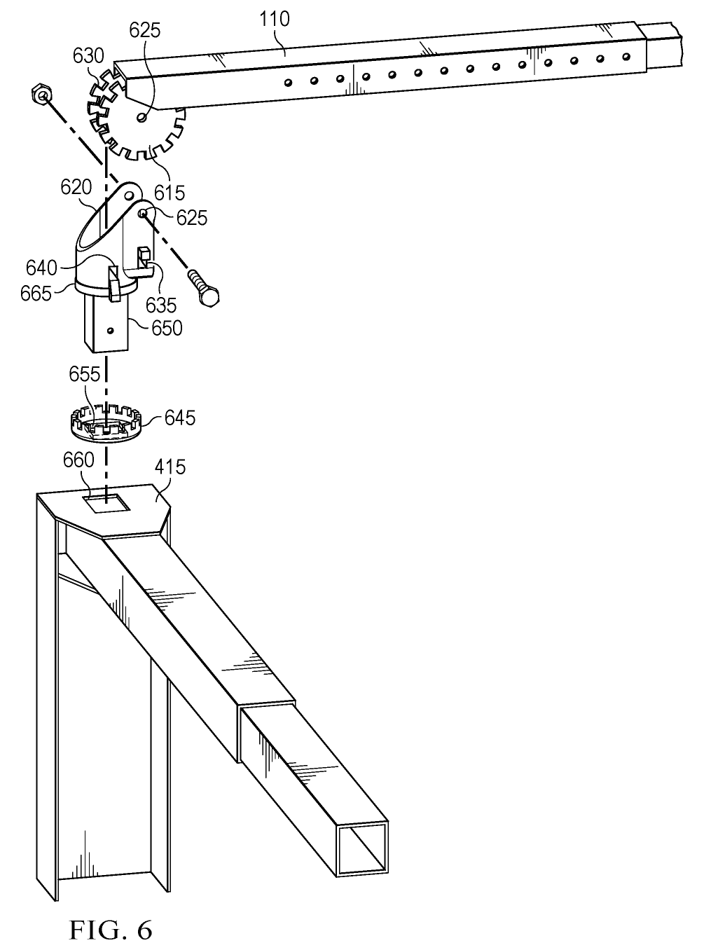

FIG. 6 illustrates a partial view of yet another ladder stabilizer that is adjustable about at least one axis, according to some embodiments of the invention. Similar to FIGS. 4-5, the embodiment illustrated in FIG. 6 includes a ladder stabilizer with multiple revolute joints, each providing a different axis of rotation. For example, the stabilizing arm 110 couples to the base 415 via a rotational gear 615 and the gear housing 620. The rotational gear 615 is coupled to the gear housing 620 via a bolt, pin, or similar axial component that passes through corresponding holes 625 in the gear housing 620 and the rotational gear 615. The rotational gear 615 is secured in a fixed rotational position via a spring latch 635 or similar mechanism. For example, the rotational gear 615 rotates freely when the spring latch 635 is disengaged and held in a fixed position when the spring latch 635 is engaged, mating with the teeth 630 of the rotational gear 615.

The gear housing 620 mates with a crown gear 645 to provide a second revolute joint/axis of rotation. For example, a fixed portion 650 of the gear housing passes through crown gear center hole 655 and a receiving hole 660 in the base 415. The connection between the fixed portion 650 and the base 415 secures the bottom of the gear housing 620 in fixed position. The upper portion of the gear housing 620 rotates around the midportion 665. For example, the midportion 665 can include ball bearings or a similar mechanism to permit the upper portion of the gear housing 620 to rotate freely. The gear housing 620 is secured in a fixed rotational position via another spring latch 640 or similar mechanism. For example, the gear housing 620 rotates freely when the spring latch 640 is disengaged and held in a fixed position when the spring latch 640 is engaged, mating with the teeth of the crown gear 645.

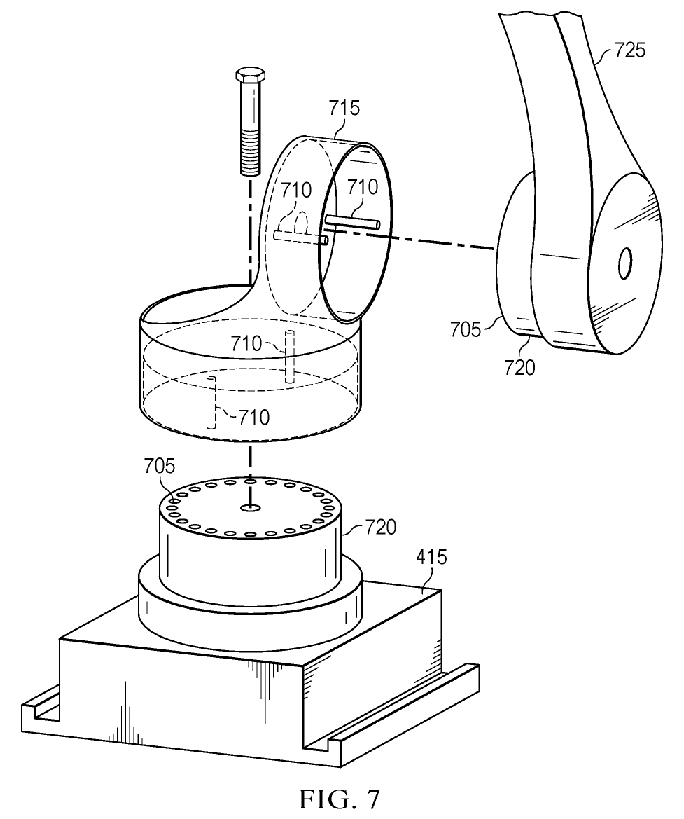

FIG. 7 illustrates an exploded view of components of another adjustable ladder stabilizer, according to some embodiments of the invention. Similar to the embodiments described above, the embodiment illustrated in FIG. 7 includes a ladder stabilizer with multiple revolute joints, each providing a different/orthogonal axis of rotation. For example, each revolute joint includes holes 705 in a corresponding raised cylindrical portion 720. The pins 710 in the dual revolute joint housing 715 mate with the holes 705 to hold the stabilizer arm 725 and dual revolute joint housing 715 in fixed rotational positions, respectively. For example, a spring-loaded pin, screw, bolt, etc. can hold the components together in fixed rotational positions. When the raised cylindrical portion 720 of the arm 725 is pulled away from the pins 710 in the upper portion of the dual revolute joint housing 715, the arm 725 can rotate freely. Similarly, when the dual revolute joint housing 715 is pulled away from the raised cylindrical portion 720 of the base 415, the pins 710 are free from the holes 705 and the dual revolute joint housing 715 can rotate freely around another axis.

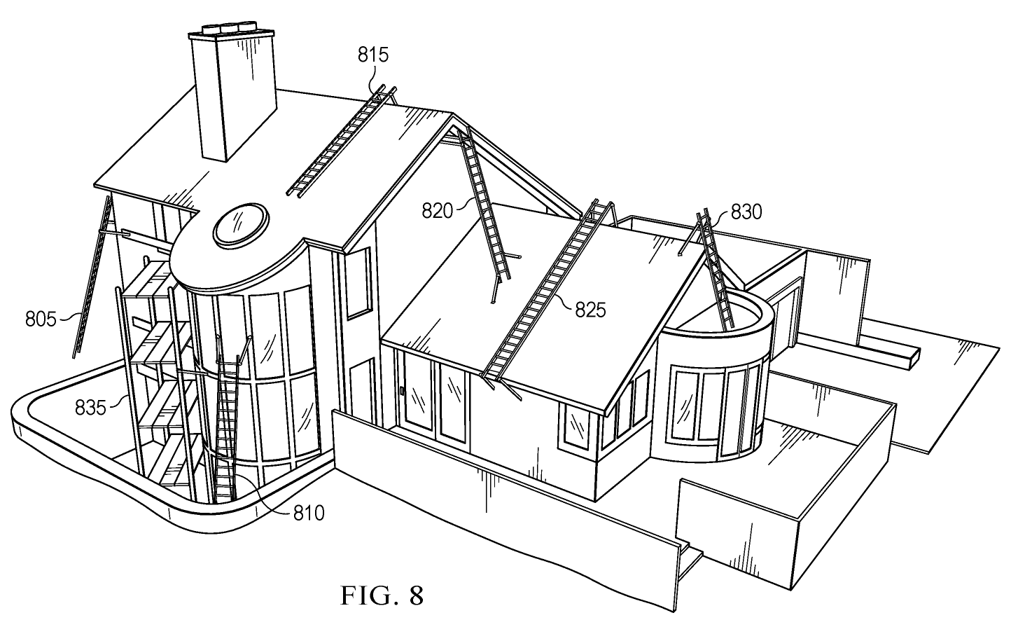

FIG. 8 illustrates examples of ladders and scaffolding using adjustable stabilizer arms, according to some embodiments of the invention. For example, each stabilizer can rotate around one or more axes near a connection point to the corresponding upright support to accommodate different circumstances.

A first ladder 805 is used to reach an upper portion of a corner of the building. The stabilizer arms are adjusted to a relatively horizontal fixed rotational position to support the ladder on that corner with greater stability than, e.g., propping a rung of the first ladder 805 against the corner.

A second ladder 810 provides access to an upper window. It would be unsafe to prop the second ladder 810 against the glass of the window, so the stabilizer arms are adjusted to an upward and slightly splayed fixed rotational position to make the contact points for the ladder on the framing on either side of the window.

A third ladder 815 provides access along the rooftop. The footing of the third ladder 815 makes relatively insecure contact with the rooftop, so the stabilizer arms are adjusted to a fixed rotational position to make the contact points for the third ladder 815 with the portion of the roof on the opposite side of the ridge of the rooftop. As a result, the stabilizer arms of the third ladder 815 form a hook for the third ladder 815 with the ridge of the roof.

A fourth ladder 820 utilizes two sets of ladder stabilizer arms. On the upper portion of the fourth ladder 820, a first set of stabilizer arms are adjusted to a horizontal fixed rotational position to brace the fourth ladder 820 against the upright wall of the building while still providing to the portion of the rooftop that overhangs the upright wall. The second set of stabilizer arms are adjusted to fixed rotational positions to provide additional stability to the base of the fourth ladder 820. In addition to being positioned at a downward angle, the second set of stabilizer arms are each adjusted in a fixed position that extends sideways, respectively, from the ladder. The base of each arm of the second set is adjusted to a position on the respective upright support of the ladder to compensate for the angle of the rooftop supporting the base of the fourth ladder 820. Without the second set of stabilizer arms, the rooftop supporting the base of the fourth ladder 820 would cause the fourth ladder 820 to lean at an angle similar to the rooftop. Alternatively to unequal height placement of the bases of the stabilizer arms, the fourth ladder 820 could be supported on an uneven surface by extending the length of one of the stabilizer arms.

A fifth ladder 825 provides access along the rooftop. Like the third ladder 815, the upper stabilizer arms are adjusted to a fixed rotational position to make the contact points for the fifth ladder 825 with the portion of the roof on the opposite side of the ridge of the rooftop. Unlike the third ladder 815, the footing of the fifth ladder 825 extends too far to make solid contact with the rooftop, so the base stabilizer arms are adjusted to a fixed rotational position to make the contact points for the fifth ladder 825 with the upright wall of the building below the rooftop.

A sixth ladder 830 provides access to a rooftop ridge. Unlike the fourth ladder 820, the upper portion of the sixth ladder 830 extends above the rooftop ridge. As a result, the stabilizer arms are adjusted to a downward fixed rotational position to brace the sixth ladder 830 against the roof on either side of the ridge.

The scaffolding 835 provides access to a range of heights along a side of the building. Like the ladders, the scaffolding has at least one stabilizer arm coupled to an upright support of the scaffolding 835. For example, the visible stabilizer arm extends horizontally and outward at a fixed rotational position to support the scaffolding 835 by making contact with the framing between windows. This support prevents the scaffolding 835 from leaning on the building and, potentially, damaging the windows.

The numerous illustrated stabilizer arms on ladders and scaffolding provide some examples of the different rotational positions the stabilizer arms can take when clamped on, or otherwise affixed to, an upright support. Having one or more axes of rotation in adjusting the arms allows a single stabilizer to function in many different scenarios. This can be further enhanced when the stabilizer arms are also adjustable in length.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An apparatus comprising:
a base including at least one moveable component and a clamping component, wherein a portion of the base is shaped to at least partially encompass an upright support of a ladder or scaffolding and the clamping component exerts force on the moveable component to hold the base in a fixed position on the upright support when at least partially encompassed within the base;
a stabilizing arm; and
a joint coupling the stabilizing arm to the base, wherein the stabilizing arm pivots about at least one axis at the joint.

2. The apparatus of claim 1, wherein the stabilizing arm pivots about multiple axes at the joint.

3. The apparatus of claim 1, wherein the joint includes a locking component to hold the stabilizing arm in a fixed position.

4. The apparatus of claim 3, wherein the joint is a ball joint including a ball and a socket.

5. The apparatus of claim 4, wherein the ball includes indentations, the socket includes and the socket includes raised portions that mate with the indentations, and the locking component is a second clamping component that clamps the socket around the ball and mates the indentations and raised portions.

6. The apparatus of claim 3, wherein the locking component is a pin or bolt.

7. The apparatus of claim 3, wherein the locking component is a spring latch.

8. The apparatus of claim 1, wherein the stabilizing arm includes multiple telescopic components and an arm locking component that locks the telescopic components in different positions, the different positions resulting in the stabilizing arm having a variable length.

9. The apparatus of claim 1, wherein the joint includes a first revolute joint that provides a first axis of rotation to the stabilizing arm.

10. The apparatus of claim 9, wherein the joint includes a second revolute joint that provides a second axis of rotation to the stabilizing arm.

11. A ladder stabilizing system comprising:
a ladder having an upright support;
a ladder stabilizer including:
a base including at least one moveable component and a clamping component, wherein a portion of the base is shaped to at least partially encompass the upright support of the ladder and the clamping component exerts force on the moveable component to hold the base in a fixed position on the upright support when at least partially encompassed within the base;
a stabilizing arm; and
a joint coupling the stabilizing arm to the base, wherein the stabilizing arm pivots about at least one axis at the joint.

12. The system of claim 11, wherein the stabilizing arm pivots about multiple axes at the joint.

13. The system of claim 11, wherein the joint includes a locking component to hold the stabilizing arm in a fixed position.

14. The system of claim 13, wherein the joint is a ball joint including a ball and a socket.

15. The system of claim 14, wherein the ball includes indentations, the socket includes and the socket includes raised portions that mate with the indentations, and the locking component is a second clamping component that clamps the socket around the ball and mates the indentations and raised portions.

16. The system of claim 13, wherein the locking component is a pin or bolt.

17. The system of claim 13, wherein the locking component is a spring latch.

18. The system of claim 11, wherein the stabilizing arm includes multiple telescopic components and an arm locking component that locks the telescopic components in different positions, the different positions resulting in the stabilizing arm having a variable length.

19. The system of claim 11, wherein the joint includes a first revolute joint that provides a first axis of rotation to the stabilizing arm.

20. The system of claim 19, wherein the joint includes a second revolute joint that provides a second axis of rotation to the stabilizing arm.
